(19) United States
(12) Patent Application Publication
(10) Pub. No.: US 2018/0296984 A1
(43) Pub. Date: Oct. 18, 2018

(54) METHOD OF PRODUCING GAS SEPARATION MEMBRANE, GAS SEPARATION MEMBRANE, GAS SEPARATION MEMBRANE MODULE, AND GAS SEPARATOR

(71) Applicant: FUJIFILM Corporation, Tokyo (JP)

(72) Inventor: Satoshi YONEYAMA, Kanagawa (JP)

(73) Assignee: FUJIFILM Corporation, Tokyo (JP)

(21) Appl. No.: 16/012,772

(22) Filed: Jun. 20, 2018

Related U.S. Application Data
(63) Continuation of application No. PCT/JP2016/088806, filed on Dec. 27, 2016.

(30) Foreign Application Priority Data
Jan. 12, 2016 (JP) 2016-003797

(51) Int. Cl. B01D 67/00; B01D 53/22; B01D 69/12; B01D 71/70; B01D 63/10; C09D 183/04; C08J 7/04

(52) U.S. Cl. CPC B01D 67/0093; B01D 53/228; B01D 69/12; B01D 71/70; C08J 2483/04; C09D 183/04; C08J 7/047; B01D 2323/345; C08J 2333/20; B01D 63/10

(57) ABSTRACT

A method of producing a gas separation membrane, includes: an ultraviolet ozone treatment of irradiating a resin layer precursor which has a siloxane bond with light containing ultraviolet rays having a wavelength of 185 nm and ultraviolet rays having a wavelength of 254 nm to form a resin layer that contains a compound having a siloxane bond, in which a cumulative irradiation dose of the ultraviolet rays having a wavelength of 185 nm is in a range of 6.0 to 17.0 J/cm², a cumulative irradiation dose of the ultraviolet rays having a wavelength of 254 nm is in a range of 120 to 330 J/cm², and the compound having a siloxane bond contained in the resin layer includes a repeating unit represented by Formula (2) or a repeating unit represented by Formula (3).

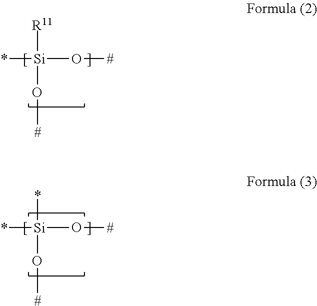

### CROSS-REFERENCE TO RELATED APPLICATIONS

This application is a Continuation of PCT International Application No. PCT/JP2016/88806, filed on Dec. 27, 2016, which claims priority under 35 U.S.C. § 119(a) to Japanese Patent Application No. 2016-003797, filed on Jan. 12, 2016. Each of the above application(s) is hereby expressly incorporated by reference, in its entirety, into the present application.

### BACKGROUND OF THE INVENTION

### 1. Field of the Invention

The present invention relates to a method of producing a gas separation membrane, a gas separation membrane, a gas separation membrane module, and a gas separator. More specifically, the present invention relates to a method of producing a gas separation membrane which has a high gas separation selectivity under a high pressure and an excellent productivity, a gas separation membrane which has a high gas separation selectivity under a high pressure, a gas separation membrane module using the gas separation membrane, and a gas separator using the gas separation membrane module.

### 2. Description of the Related Art

A material formed of a polymer compound has a gas permeability specific to the material. Based on this property, it is possible to cause selective permeation and separation out of a target gas component using a membrane formed of a specific polymer compound (gas separation membrane). As an industrial use aspect for this gas separation membrane related to the problem of global warming, separation and recovery of carbon dioxide from large-scale carbon dioxide sources with this gas separation membrane has been examined in thermal power plants, cement plants, or ironworks blast furnaces. Further, this membrane separation technique has been attracting attention as a means for solving environmental issues which can be achieved with relatively little energy. For example, means for removing carbon dioxide from natural gas mainly including methane and carbon dioxide or biogas (biological excrement, organic fertilizers, biodegradable substances, sewage, garbage, fermented energy crops, or gas generated due to anaerobic digestion) has been used.

The following methods have been known as a method of securing gas permeability and gas separation selectivity by making a site contributing to gas separation into a thin layer to be used as a practical gas separation membrane. A method of utilizing an asymmetric membrane by making a portion contributing to gas separation into a thin layer which is referred to as a skin layer, a method of utilizing a thin layer composite membrane (thin film composite) provided with a thin film layer (selective layer) contributing to gas separation which is disposed on a support having mechanical strength, or a method of utilizing hollow fibers including a layer with a high density which contributes to gas separation has been known.

As typical performance of a gas separation membrane, gas separation selectivity shown in a case where target gas is obtained from mixed gas and gas permeability of target gas are exemplified. For the purpose of enhancing the gas permeability or gas separation selectivity, gas separation membranes having various configurations have been examined.

For example, JP2005-74342A describes a membrane separator formed by using an electromagnetic wave, which includes a separation membrane through which at least one separated molecular species can permeate as a permeating molecular species from a group having at least two separated molecular species; and an electromagnetic irradiation source which irradiates the separation membrane with electromagnetic waves and is capable of changing an irradiation wavelength depending on the permeating molecular species that selectively permeates into the separation membrane. Further, JP2005-74342A describes a silica membrane as an example of a separation membrane and also describes ultraviolet rays as an example of electromagnetic waves to be applied from the electromagnetic wave irradiation source.

JP1989-67210A (JP-H01-67210A) describes a method of producing a selective gas permeating composite membrane which includes forming a polymer thin film formed of polyorganosiloxane or a polyorganosiloxane copolymer, which does not have a film forming ability, on a porous support, providing an acetylene polymer thin film having a double bond in the main chain on the polymer thin film, composing the film, and performing an ultraviolet treatment on the surface thereof.

JP1996-503655A (JP-H08-503655A) describes a method of treating a gas separation membrane which includes heating a membrane containing a polymer, having a UV excitable site and a mobile pro-site in the main chain thereof such that a covalent bond is formed between both sites, in a temperature range of 60° C. to 300° C. for a time sufficient to relax the excess free volume in the polymer, and irradiating this membrane with UV radiation using a UV radiation source for a time sufficient to oxidize the surface of the membrane in the presence of oxygen to obtain a treated membrane, in order to improve the selectivity so that the selectivity of the treated membrane is at least 10% greater than that of an untreated membrane and a decrease in penetration rate thereof is less than 60%.

JP1998-85571A (JP-H10-85571A) describes a separation membrane formed of a hydrazide imide-based resin. Further, JP1998-85571A (JP-H10-85571A) describes that, in a case of a membrane including a non-porous dense layer formed of a hydrazide imide-based resin, a surface of the non-porous dense layer may be coated or subjected to a filling treatment with a material having high gas permeability such as silicone or polyacetylene in order to block pin holes (micropores) which are slightly generated in the non-porous dense layer of the separation membrane. Further, JP1998-85571A (JP-H10-85571A) describes that the dense layer may be subjected to a surface treatment such as a surface treatment with chlorine or fluorine gas, a plasma treatment, or an ultraviolet treatment in order to increase gas selectivity.

In addition, JP2015-66484A describes a method of producing a gas separation membrane which includes a step of performing a surface treatment on one surface of a separation layer that contains a resin; and a step of forming a protective layer on the surface of the separation layer on which the surface treatment has been performed, in which the surface treatment is performed until the oxygen atomic ratio (unit:%) of the separation layer on the protective layer side is further increased than the oxygen atomic ratio (unit:%) of the separation layer on the opposite side of the protective layer by 10% or greater. JP2015-66484A describes that a plasma treatment is preferable as the surface treatment and examples of the plasma treatment include a vacuum plasma treatment and a low-pressure plasma treatment in which argon gas has been introduced into the plasma.

### SUMMARY OF THE INVENTION

As a result of research on the gas permeating performance of the gas separation membranes described in JP2005-74342A, JP1989-67210A (JP-H01-67210A), JP1996-503655A (JP-H08-503655A), and JP1998-85571A (JP-H10-85571A), the present inventors found that there is a problem in that the gas separation selectivity under a high pressure is low. Meanwhile, it was understood that the method of using a vacuum plasma treatment or a reduced pressure plasma treatment is basically not suitable for a roll-to-roll system (hereinafter, also referred to as “RtoR”) and further improvement of productivity is required because the cost is extremely high and the running cost is also taken even in a case where facility responses have been made. Further, in a case where the method of using a vacuum plasma treatment or a reduced pressure plasma treatment is used, it takes time for reducing the pressure because decompression needs to be carried out precisely and the treatment capacity fluctuates due to the amount of introduced gas, and thus it is required to produce a gas separation membrane using another method with a high productivity.

An object of the present invention is to provide a method of producing a gas separation membrane which has a high gas separation selectivity under a high pressure and an excellent productivity.

The present inventors conducted intensive research in order to solve the above-described problems. As the result, it was found that a method of producing a gas separation membrane which has a high gas separation selectivity under a high pressure and an excellent productivity can be provided by respectively setting a cumulative irradiation dose at a wavelength of 185 nm and a cumulative irradiation dose at a wavelength of 254 nm to be in a specific range in an ultraviolet ozone treatment step of irradiating a resin layer precursor which has a siloxane bond with light containing ultraviolet rays having a wavelength of 185 nm and ultraviolet rays having a wavelength of 254 nm.

Here, there is no description on the wavelength of ultraviolet rays to be applied to a resin layer precursor having a siloxane bond; irradiation with ultraviolet rays and generation of ozone; or the cumulative irradiation dose at a wavelength of 185 nm and the cumulative irradiation dose at a wavelength of 254 nm in JP2005-74342A, JP1989-67210A (JP-H01-67210A), JP1996-503655A (JP-H08-503655A), and JP1998-85571A (JP-H10-85571A). Accordingly, there is no description that the gas separation selectivity can be increased under a high pressure by respectively setting the cumulative irradiation dose at a wavelength of 185 nm and the cumulative irradiation dose at a wavelength of 254 nm to be in a specific range in JP2005-74342A, JP1989-67210A (JP-H01-67210A), JP1996-503655A (JP-H08-503655A), and JP1998-85571A (JP-H10-85571A).

The present invention and preferred aspects of the present invention as specific means for solving the above-described problems are as follows.

[1] A method of producing a gas separation membrane, comprising: an ultraviolet ozone treatment of irradiating a resin layer precursor which has a siloxane bond with light containing ultraviolet rays having a wavelength of 185 nm and ultraviolet rays having a wavelength of 254 nm to form a resin layer that contains a compound having a siloxane bond, in which a cumulative irradiation dose of the ultraviolet rays having a wavelength of 185 nm is in a range of 6.0 to 17.0 J/cm², a cumulative irradiation dose of the ultraviolet rays having a wavelength of 254 nm is in a range of 120 to 330 J/cm², and the compound having a siloxane bond contained in the resin layer includes at least a repeating unit represented by Formula (2) or a repeating unit represented by Formula (3),

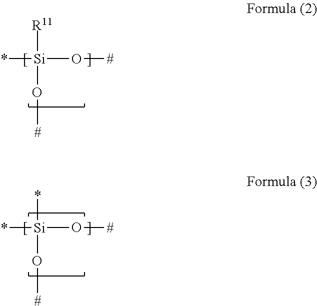

in Formulae (2) and (3), R¹¹ represents a substituent, * represents a bonding site with respect to # in Formula (2) or (3), and # represents a bonding site with respect to * in Formula (2) or (3).

[2] The method of producing a gas separation membrane according to [1], in which the ultraviolet ozone treatment is performed in an oxygen flow.

[3] The method of producing a gas separation membrane according to [1] or [2], further comprising: unwinding a composite which has the resin layer precursor from a roll; and winding a gas separation membrane after the ultraviolet ozone treatment around a roll.

[4] The method of producing a gas separation membrane according to any one of [1] to [3], in which the compound having the siloxane bond contained in the resin layer further includes a repeating unit represented by Formula (1),

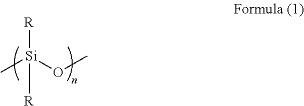

in Formula (1), R's each independently represent a hydrogen atom, an alkyl group having 1 or more carbon atoms, an aryl group, an amino group, an epoxy group, a fluorinated alkyl group, a vinyl group, an alkoxy group, or a carboxyl group, and n represents an integer of 2 or greater.

[5] The method of producing a gas separation membrane according to [4], in which the surface of the resin layer contains a compound having a siloxane bond which has a repeating unit represented by Formula (1) and a repeating unit represented by Formula (2) or a repeating unit represented by Formula (3).

[6] The method of producing a gas separation membrane according to any one of [1] to [5], in which a thickness of the resin layer is in a range of 0.4 to 5 μm.

[7] The method of producing a gas separation membrane according to any one of [1] to [6], in which the resin layer contains a compound having a repeating unit that contains at least a silicon atom, an oxygen atom, and a carbon atom.

[8] The method of producing a gas separation membrane according to any one of [1] to [7] which further includes a support.

[9] A gas separation membrane which is produced according to the method of producing a gas separation membrane according to any one of [1] to [8].

[10] The gas separation membrane according to [9] which has a roll shape.

[11] A gas separation membrane module comprising: the gas separation membrane according to [9] or [10].

[12] A gas separator comprising: the gas separation membrane module according to [11].

In the present specification, when a plurality of substituent groups or linking groups (hereinafter, referred to as substituent groups or the like) shown by specific symbols are present or a plurality of substituent groups are defined simultaneously or alternatively, this means that the respective substituent groups may be the same as or different from each other. In addition, even in a case where not specifically stated, when a plurality of substituent groups or the like are adjacent to each other, they may be condensed or linked to each other and form a ring.

In regard to compounds (including resins) described in the present specification, the description includes salts thereof and ions thereof in addition to the compounds. Further, the description includes derivatives formed by changing a predetermined part within the range in which desired effects are exhibited.

A substituent group (the same applies to a linking group) in the present specification may include an optional substituent group of the group within the range in which desired effects are exhibited. The same applies to a compound in which substitution or non-substitution is not specified.

According to the present invention, it is possible to provide a method of producing a gas separation membrane which has a high gas separation selectivity under a high pressure and an excellent productivity.

### BRIEF DESCRIPTION OF THE DRAWINGS

FIG. 1 is a view illustrating an example of a gas separation membrane.

FIG. 2 is a view illustrating another example of a gas separation membrane.

FIG. 3 is a view illustrating still another example of a gas separation membrane.

FIG. 4 is a view describing a position of a front surface of a resin layer and a surface of the resin layer at a depth d from the front surface of the resin layer (in a support direction).

FIG. 5 is a view illustrating an example of a method of producing a gas separation membrane.

FIG. 6A is a view illustrating a polydimethylsiloxane membrane on which an ultraviolet ozone treatment step has not been performed. FIG. 6B is a view illustrating a resin layer according to an example of a gas separation membrane. FIG. 6C is a view illustrating a polydimethylsiloxane membrane into which oxygen atoms have been introduced uniformly in a film thickness direction.

FIG. 7 is a view illustrating an example of a producing device used for a method of producing a gas separation membrane.

FIG. 8 is a view illustrating another example of a producing device used for a method of producing a gas separation membrane.

### DESCRIPTION OF THE PREFERRED EMBODIMENTS

Hereinafter, the present invention will be described in detail. The description of constituent elements described below is made based on the exemplary embodiments, but the present invention is not limited to such embodiments. In addition, the numerical ranges shown using “to” in the present specification indicate ranges including the numerical values described before and after “to” as the lower limits and the upper limits.

[Method of Producing Gas Separation Membrane]

A method of producing a gas separation membrane includes an ultraviolet ozone treatment step of irradiating a resin layer precursor which has a siloxane bond (hereinafter, also simply referred to as a “resin layer precursor”) with light containing ultraviolet rays having a wavelength of 185 nm and ultraviolet rays having a wavelength of 254 nm to form a resin layer that contains a compound having a siloxane bond (hereinafter, also simply referred to as a “resin layer”), in which a cumulative irradiation dose of the ultraviolet rays having a wavelength of 185 nm is in a range of 6.0 to 17.0 J/cm², a cumulative irradiation dose of the ultraviolet rays having a wavelength of 254 nm is in a range of 120 to 330 J/cm², and the compound having a siloxane bond contained in the resin layer includes a repeating unit represented by Formula (2) or a repeating unit represented by Formula (3).

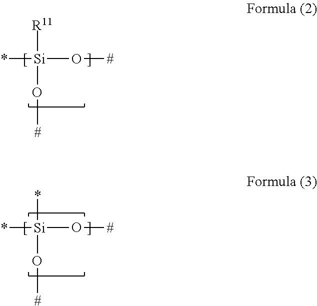

In Formulae (2) and (3), represents a substituent, the symbol “*” represents a bonding site with respect to # in Formula (2) or (3), and the symbol “#” represents a bonding site with respect to * in Formula (2) or (3).

According to the method of producing a gas separation membrane, with the above-described configuration, the gas separation membrane has a high gas separation selectivity under a high pressure and an excellent productivity.

The ultraviolet ozone treatment step is a step of performing an oxidation treatment on a surface of the resin layer precursor. The reaction caused by the ultraviolet ozone treatment progresses in the following manner. Oxygen molecules are decomposed due to ultraviolet rays having a wavelength of approximately 185 nm applied from a UV lamp so that oxygen atoms are generated. Next, the generated oxygen atoms are bonded to O₂ (oxygen molecules) in air to generate ozone (O₃). The generated O₃ (ozone) is irradiated with ultraviolet rays having a wavelength of 254 nm so that the ozone is decomposed, and O⁻ (active oxygen) in an excited state is generated. These reactions are simultaneously repeated to provide an oxygen-rich state, and thus the active oxygen directly collides with the resin layer precursor. By respectively controlling the cumulative irradiation dose at a wavelength of 185 nm and the cumulative irradiation dose at a wavelength of 254 nm to be in a specific range in the ultraviolet ozone treatment, a gas separation membrane in which the compound having a siloxane bond contained in the resin layer has at least a repeating unit represented by Formula (2) or a repeating unit represented by Formula (3) is obtained. An increase in gas separation selectivity of the gas separation membrane under a high pressure has been experimentally found by the following examples in a case where the cumulative irradiation dose of ultraviolet rays having a wavelength of 185 nm is in a range of 6.0 to 17.0 J/cm² and the cumulative irradiation dose of ultraviolet rays having a wavelength of 254 nm is in a range of 120 to 330 J/cm².

In a case of the ultraviolet ozone treatment, since the treatment can be performed in an atmospheric pressure and a roll-to-roll treatment can be also performed, the productivity can be remarkably improved compared to a vacuum plasma treatment or a reduced pressure plasma treatment.

Further, according to a preferred aspect of the method of producing a gas separation membrane of the present invention, the gas separation membrane can be produced in a large area at a low cost.

A preferred aspect of the method of producing a gas separation membrane according to the present invention will be described below.

<Formation of Resin Layer Precursor Having Siloxane Bond>

It is preferable that the method of producing a gas separation membrane includes a step of forming the resin layer precursor on the support described above.

The method of forming the resin layer precursor on the support is not particularly limited, but it is preferable that the support is coated with a composition containing a component of the resin layer precursor and an organic solvent.

The coating method is not particularly limited and a known method can be used. As the known method, a spin coating method, a dip coating method, or a bar coating method can be used as appropriate.

The composition containing a component of the resin layer precursor and an organic solvent is a curable composition.

As the resin layer precursor having a siloxane bond, a compound having a siloxane bond is exemplified, and it is preferable that the compound contains at least one selected from polydimethylsiloxane (PDMS), polydiphenylsiloxane, polydi(trifluoropropyl)siloxane, polymethyl(3,3,3-trifluoropropyl)siloxane, and poly(l-trimethylsilyl-1-propyne) (PTMSP), more preferable that the compound contains polydimethylsiloxane or poly(l-trimethylsilyl-1-propyne), and still more preferable that the compound contains polydimethylsiloxane.

A preferred aspect of the step of forming the resin layer precursor on the above-described support will be described. With a support 4, it is preferable that a surface of the support 4 is coated with a composition (hereinafter, also referred to as a “silicone coating solution”) that forms a resin layer precursor 2 using so-called RtoR. The RtoR is a production method which includes drawing out a long sheet from a roll around which the sheet has been wound, transporting the sheet in a longitudinal direction, performing a treatment such as coating or curing, and winding the treated sheet in a roll shape.

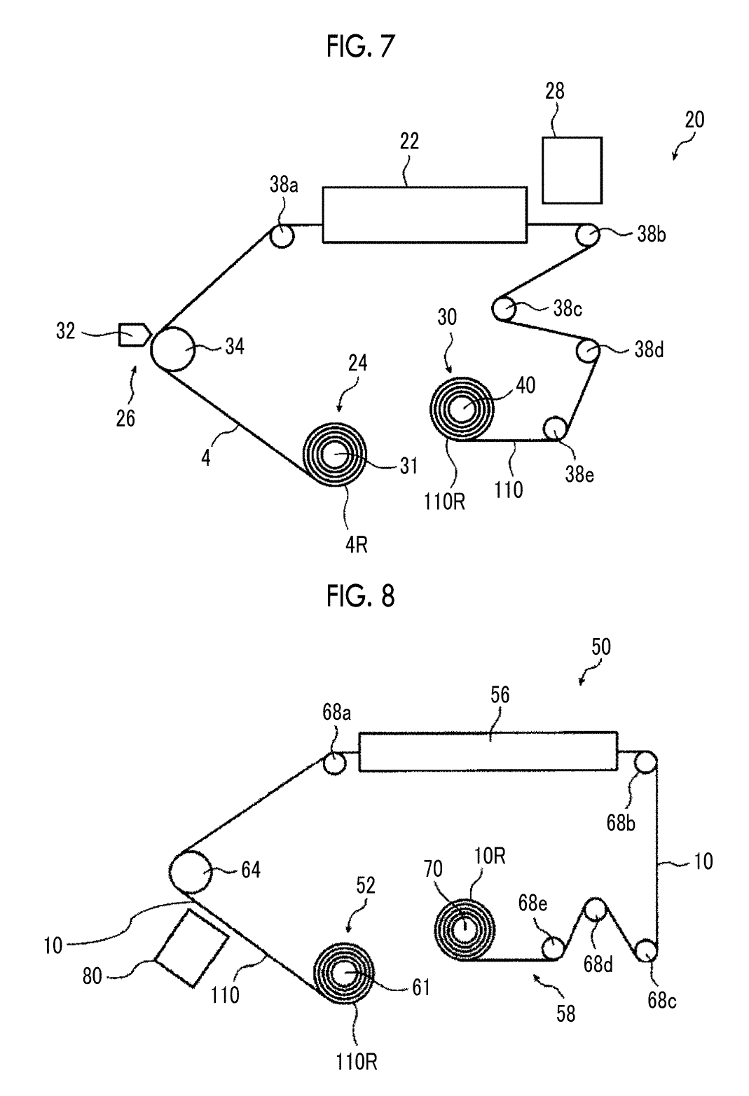

FIG. 7 is a view illustrating an example of a producing device used for the method of producing a gas separation membrane. Further, as the producing device used for the method of producing a gas separation membrane of the present invention, it is preferable to use a producing device described in paragraphs <0017> to <0121> of JP2015-107473A, and the contents of this publication are incorporated herein by reference.

As described above, according to the method of producing a gas separation membrane, a composite 110 (a composite having a resin layer precursor before the ultraviolet ozone treatment) is produced using RtoR. A long support 4 is sent out by a producing device 20 from a support roll 4R obtained by winding the support 4 (web-like support 4) in a roll shape. A surface of the support 4 is coated with a silicone coating solution formed of the resin layer precursor 2 while the support 4 is transported in the longitudinal direction by the producing device 20. Next, the silicone coating solution which has been applied to the support 4 is cured by the producing device 20 to form the resin layer precursor 2. The support 4 on which the resin layer precursor 2 has been formed is set as the composite 110. The composite 110 prepared in the above-described manner is wound in a roll shape, thereby obtaining a composite roll 110R.

Such a producing device 20 basically includes a supply unit 24, a coating unit 26, a drying device 22 which may be optionally provided, an exposing device 28 which may be optionally provided, and a winding unit 30.

In addition to the members illustrated in FIG. 7, the producing device 20 may further include various members provided for a device that produces a functional membrane (functional film) according to RtoR, such as a pass roller (guide roller), a pair of transport rollers, a transport guide, and various sensors.

The supply unit 24 is a portion which allows a support roll 4R obtained by winding the long support 4 around a rotating shaft 31 in a roll shape to be mounted on the rotating shaft 31 and allows the support 4 to be sent out by rotating the rotating shaft 31 (that is, the support roll 4R).

In the supply unit 24, sending out and transporting of the support 4 may be performed according to a known method.

The support 4 which has been sent out from the support roll 4R is transported to the coating unit 26 and coated with a silicone coating solution that forms the resin layer precursor 2 while being transported in the longitudinal direction.

In the example illustrated in FIG. 7, the coating unit 26 includes a coating device 32 and a backup roller 34. The support 4 is transported in the longitudinal direction while being supported by the backup roller 34 at a predetermined position, and the surface of the support 4 is coated with the silicone coating solution.

As the coating device 32, various known devices can be used.

Specific examples thereof include a roll coater, a direct gravure coater, an offset gravure coater, a one-roll kiss coater, a three-reverse roll coater, a forward rotation roll coater, a curtain flow coater, an extrusion die coater, an air doctor coater, a blade coater, a rod coater, a knife coater, a squeeze coater, a reverse roll coater, and a bar coater.

Among these, from the viewpoint of controlling the viscosity of the silicone coating solution, the coating amount of the silicone coating solution, and the permeation amount of the silicone resin, a roll coater, a direct gravure coater, an offset gravure coater, a one-roll kiss coater, a three-reverse roll coater, a forward rotation roll coater, a squeeze coater, and a reverse roll coater are suitably used.

Next, the support 4 coated with the silicone coating solution by the coating unit 26 is transported to the drying device 22, and the solvent of the silicone coating solution is dried. In a case where the silicone coating solution contains a thermosetting resin, it is preferable that the silicone coating solution is cured (a monomer or the like is cross-linked) while the support 4 is transported in the longitudinal direction in the drying device 22 to obtain the composite 110 provided with the resin layer precursor 2 formed on the surface of the support 4. In this case, exposure to ultraviolet rays or the like using the exposing device 28 described below may not be performed.

Next, the support 4 which has been transported to the drying device 22 is transported to the exposing device 28 to be provided as necessary. It is preferable that the exposing device 28 is disposed on a further downstream side than the drying device 22 provided on a downstream side of the coating unit 26 in the transport direction of the support. In a case where the silicone coating solution contains a thermosetting resin, it is preferable that the silicone coating solution is cured (a monomer or the like is cross-linked) while the support 4 is transported in the longitudinal direction by the exposing device 28 to obtain the composite 110 that has the resin layer precursor 2 formed on the surface of the support 4.

The composite 110 which has the resin layer precursor 2 formed by curing the silicone coating solution using the drying device 22 or the exposing device 28 is guided by pass rollers 38a, 38b, 38c, and 38d and then transported to the winding unit 30.

Further, the pass rollers 38b, 38c, and 38d act as a tension cutter and guide the composite 110 so as to meander.

The winding unit 30 winds the composite 110 to obtain the composite roll 110R and includes a pass roller 38e and a winding shaft 40.

The composite 110 which has been transported to the winding unit 30 is guided to the winding shaft 40 by a pass roller 64e and wound up by the winding shaft 40 so that the composite roll 110R is obtained.

<Step of Unwinding Composite from Roll>

From the viewpoint of forming a gas separation membrane using RtoR, it is preferable that the method of producing a gas separation membrane of the present invention includes a step of unwinding the composite (support having a surface on which the resin layer precursor has been formed) that contains the resin layer precursor from the roll.

FIG. 8 illustrates an example of a producing device 50 used for the step of unwinding the composite from the roll, the ultraviolet ozone treatment step, a step of providing a protective layer, and a step of winding the protective layer around the roll. FIG. 8 is a view illustrating another example of a producing device used for the method of producing a gas separation membrane. Hereinafter, a case where the resin layer precursor 2 is subjected to an ultraviolet ozone treatment to form the resin layer 3 will be described as an example.

It is preferable that RtoR is also used for the ultraviolet ozone treatment step in the method of producing a gas separation membrane. Even the producing device 50, illustrated in FIG. 8, allows the composite 110 to be sent out from the composite roll 110 R around which the long composite 110 has been wound. In the producing device 50, the resin layer precursor 2 is subjected to the ultraviolet ozone treatment by an ultraviolet ozone treatment device 80 while the composite 110 is transported in the longitudinal direction so that the resin layer 3 is obtained. Further, a prepared gas separation membrane 10 is wound in a roll shape by the producing device 50 to obtain a gas separation membrane roll 10R.

Such a producing device 50 basically includes a supply unit 52, the ultraviolet ozone treatment device 80, and a winding unit 58. The producing device 50 may optionally include a drying device 56.

In addition to the members illustrated in the figure, similar to the producing device 20 described above, the producing device 50 may further include various members provided for a device that produces a functional membrane according to RtoR, such as a pass roller and various sensors as necessary.

The supply unit 52 is a portion which allows the composite roll 110R obtained by winding the composite 110 around a rotating shaft 61 in a roll shape to be mounted on the rotating shaft 61 while a protective layer 8 is formed on the composite 110 and allows the composite 110 to be sent out by rotating the rotating shaft 61, that is, the composite roll 110R.

Similar to the producing device 20 described above, sending out and transporting the composite 110 may be performed according to a known method.

<Ultraviolet Ozone Treatment Step>

The method of producing a gas separation membrane of the present invention includes an ultraviolet ozone treatment step of irradiating the resin layer precursor with light containing ultraviolet rays having a wavelength of 185 nm and ultraviolet rays having a wavelength of 254 nm to form a resin layer, in which a cumulative irradiation dose of the ultraviolet rays having a wavelength of 185 nm is in a range of 6.0 to 17.0 J/cm² and a cumulative irradiation dose of the ultraviolet rays having a wavelength of 254 nm is in a range of 120 to 330 J/cm².

According to the method of producing a gas separation membrane of the present invention, the cumulative irradiation dose of ultraviolet rays having a wavelength of 185 nm is preferably in a range of 7.0 to 16.0 J/cm² from the viewpoint that the gas separation membrane has an excellent gas permeability and an excellent gas separation selectivity under a high pressure, more preferably in a range of 8.0 to 15.0 J/cm², and still more preferably in a range of 10.0 to 13.0 J/cm². An illuminance of the ultraviolet rays having a wavelength of 185 nm is preferably in a range of 1.0 to 6.0 mW/cm², more preferably in a range of 2.0 to 5.0 mW/cm², and still more preferably in a range of 3.0 to 4.0 mW/cm².

According to the method of producing a gas separation membrane of the present invention, the cumulative irradiation dose of ultraviolet rays having a wavelength of 254 nm is preferably in a range of 130 to 320 J/cm² from the viewpoint that the gas separation membrane has an excellent gas permeability and an excellent gas separation selectivity under a high pressure, more preferably in a range of 150 to 300 J/cm², and still more preferably in a range of 200 to 250 J/cm². An illuminance of the ultraviolet rays having a wavelength of 254 nm is preferably in a range of 40 to 100 mW/cm², more preferably in a range of 60 to 80 mW/cm2, and still more preferably in a range of 65 to 70 mW/cm².

The cumulative irradiation dose of ultraviolet rays can be acquired as a product between the illuminance of ultraviolet rays and the irradiation time of ultraviolet rays. Accordingly, in a case where the cumulative irradiation dose of ultraviolet rays having a wavelength of 185 nm is in a range of 6.0 to 17.0 J/cm2 and the cumulative irradiation dose of the ultraviolet rays having a wavelength of 254 nm is in a range of 120 to 330 J/cm2, the irradiation time of ultraviolet rays is not particularly limited. For example, the irradiation time of ultraviolet rays under the above-described conditions is in a range of 5 to 200 minutes, more preferably in a range of 30 to 70 minutes, and still more preferably in a range of 50 to 60 minutes. Further, the irradiation time of ultraviolet rays can be controlled by controlling the transport speed of the resin layer precursor.

According to the method of producing a gas separation membrane of the present invention, it is preferable that the ultraviolet ozone treatment step is performed in an oxygen flow from the viewpoint that the gas separation membrane has an excellent gas permeability and an excellent gas separation selectivity under a high pressure. The oxygen flow rate in a case where the ultraviolet ozone treatment step is performed in an oxygen flow is preferably in a range of 0.1 to 10.0 L/min, more preferably in a range of 0.3 to 5.0 L/min, and still more preferably in a range of 0.5 to 1.5 L/min.

From the viewpoint of increasing the productivity, it is preferable that the ultraviolet ozone treatment step is performed in an atmospheric pressure.

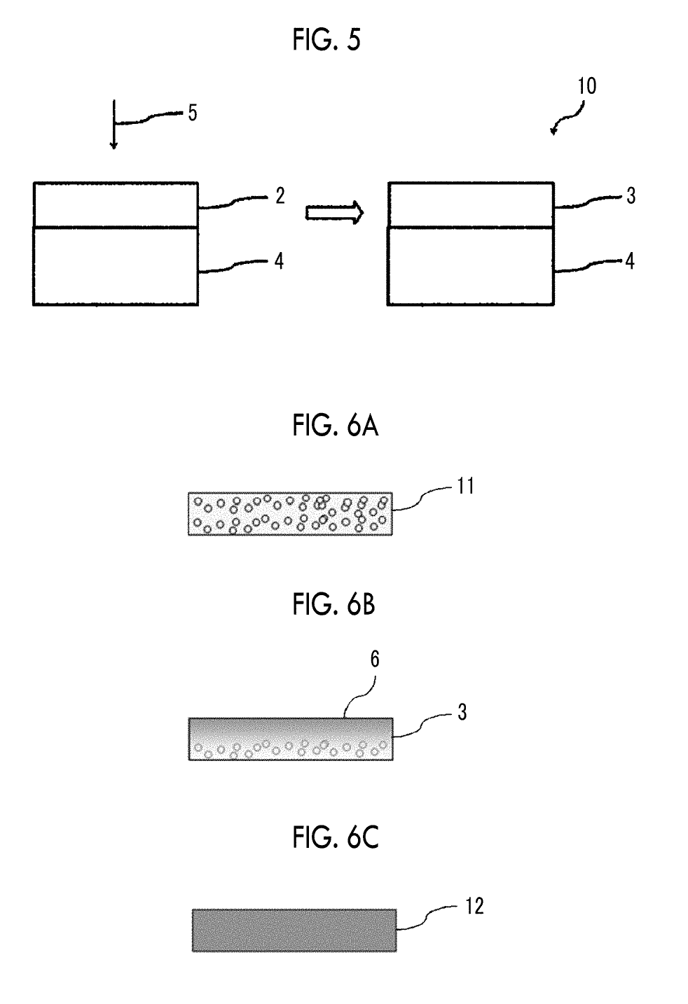

The ultraviolet ozone treatment according to the method of producing a gas separation membrane will be described with reference to the accompanying drawings. As illustrated in FIG. 5, according to the method of producing a gas separation membrane, it is preferable that an ultraviolet ozone treatment 5 is performed on a laminate of the support 4 and the resin layer precursor 2 from one surface side of the resin layer precursor 2 to form the resin layer 3.

According to an example of the producing device used for the method of producing a gas separation membrane illustrated in FIG. 8, the resin layer precursor 2 is subjected to the ultraviolet ozone treatment by the ultraviolet ozone treatment device 80 while the composite 110 which has been sent out from the composite roll 110R is transported in the longitudinal direction so that the resin layer 3 is obtained. As the result, the gas separation membrane 10 in which the compound having a siloxane bond contained in the resin layer has at least a repeating unit represented by Formula (2) or a repeating unit represented by Formula (3) is obtained.

According to the method of producing a gas separation membrane of the present invention, the compound having a siloxane bond contained in the resin layer formed during the ultraviolet ozone treatment step described above has at least a repeating unit represented by Formula (2) or a repeating unit represented by Formula (3).

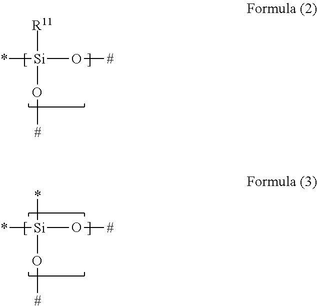

In Formulae (2) and (3), represents a substituent, the symbol “*” represents a bonding site with respect to # in Formula (2) or (3), and the symbol “#” represents a bonding site with respect to * in Formula (2) or (3).

The preferable composition of the resin layer formed during the ultraviolet ozone treatment step will be described in the section of the resin layer of the gas separation membrane of the present invention.

<Method of Preparing Additional Resin Layer>

The method of producing a gas separation membrane may include a step of forming an additional resin layer, other than the resin layer, on a surface (on the resin layer) of the resin layer precursor on which the ultraviolet ozone treatment 5 has been performed (not illustrated).

The method of preparing the additional resin layer other than the resin layer is not particularly limited, and the additional resin layer may be formed by obtaining a commercially available product of a known material, may be formed according to a known method, or may be formed according to a method described below using a specific resin.

The method of forming the additional resin layer other than the resin layer is not particularly limited, but it is preferable that an underlayer (for example, a resin layer) is coated with a composition including a material of the additional resin layer other than the resin layer and an organic solvent. The coating method is not particularly limited and the coating can be performed according to a known method, for example, a spin coating method.

The conditions for forming the additional resin layer other than the resin layer are not particularly limited, but the temperature thereof is preferably in a range of −30° C. to 100° C., more preferably in a range of −10° C. to 80° C., and still more preferably in a range of 5° C. to 50° C.

In the present invention, the air and a gas such as oxygen may coexist at the time of forming the additional resin layer other than the resin layer, but it is desired that the additional resin layer is formed in an inert gas atmosphere.

<Step of Providing Protective Layer>

The method of producing a gas separation membrane may include a step of providing a protective layer on the resin layer of the gas separation membrane during a period after the completion of the ultraviolet ozone treatment and before the winding.

The method of providing a protective layer on the resin layer is not particularly limited. According to the method of producing a gas separation membrane, it is preferable that the protective layer is provided by a coating method or a vapor deposition method and more preferable that the protective layer is provided by coating the resin layer with the composition containing the material of the protective layer and an organic solvent from the viewpoint of the production cost. As the organic solvent, an organic solvent used for forming a resin layer precursor may be exemplified. The coating method is not particularly limited and a known method can be used. For example, a spin coating method can be used.

A curable composition may be used as the material of the protective layer. The method of irradiating a curable composition with radiation during the formation of the protective layer is not particularly limited. Since electron beams, ultraviolet (UV) rays, visible light, or infrared rays can be used for irradiation, the method can be appropriately selected according to the material to be used.

The time for irradiation with radiation is preferably in a range of 1 to 30 seconds. The radiant energy is preferably 10 to 2,000 mW/cm².

In the example illustrated in FIG. 8, the gas separation membrane 10 is transported in the longitudinal direction while being supported by a backup roller 64 at a predetermined position.

<Step of Winding Gas Separation Membrane Around Roll>

From the viewpoint of forming a gas separation membrane according to RtoR, it is preferable that the method of producing a gas separation membrane of the present invention includes a step of winding the gas separation membrane around the roll after the ultraviolet ozone treatment step.

In the example of the method of producing a gas separation membrane illustrated in FIG. 8, the gas separation membrane 10 is transported to the winding unit 58 by being guided by a pass roller 68b.

The winding unit 58 is a unit that winds the gas separation membrane 10 around the winding shaft 70 to obtain the gas separation membrane roll 10R.

The winding unit 58 includes the above-described winding shaft 70 and three pass rollers 68c to 68e.

The gas separation membrane 10 is guided to a predetermined transport path by the pass rollers 68c to 68e and wound around the winding shaft 70 so that the gas separation membrane roll 10R is obtained.

[Gas Separation Membrane]

The gas separation membrane of the present invention is a gas separation membrane produced according to the method of producing a gas separation membrane of the present invention.

In the gas separation membrane of the present invention, the resin layer functions as a layer having a high gas separation selectivity, that is, so-called separation selectivity. The gas separation membrane of the present invention is a gas separation membrane having a high gas separation selectivity. It is not intended to adhere to any theory, but it is considered that the separation selectivity is exhibited by the oxygen atoms entering not only the surface of the resin layer but also the inside of the resin layer in the thickness direction.

A layer having separation selectivity indicates a layer in which a ratio (PCO₂/PCH₄) of a permeation coefficient (PCO₂) of carbon dioxide to a permeation coefficient (PCH₄) of methane, in a case where a membrane having a thickness of 0.1 to 30 μm is formed and pure gas of carbon dioxide (CO₂) and methane (CH₄) is supplied to the obtained membrane at a temperature of 40° C. by setting the total pressure of the gas supply side to 0.5 MPa, is 1.5 or greater.

In the related art, a layer containing a polyimide compound has been frequently used as the layer having a separation selectivity of a gas separation membrane. The configuration of the gas separation membrane having a high gas separation selectivity under a high pressure by means of having a resin layer on which the ultraviolet ozone treatment has been performed in place of the layer containing a polyimide compound has not been known in the related art.

Here, the gas permeability and the gas separation selectivity of the gas separation membrane are typically in a trade-off relationship. That is, in the gas separation membrane, there is a tendency that the gas separation selectivity is decreased in a case where the gas permeability is increased and the gas separation selectivity is increased in a case where the gas permeability is decreased. Accordingly, it is difficult to increase both of the gas permeability and the gas separation selectivity in a case of a gas separation membrane of the related art. Meanwhile, it is possible to increase both of the gas permeability and the gas separation selectivity in a case of the gas separation membrane of the present invention.

This is because the gas separation membrane of the present invention includes the resin layer 3 which has a structure into which oxygen atoms have been introduced with a gradation from the surface as illustrated in FIG. 6B. The portion into which oxygen atoms have been introduced is provided with holes due to the siloxane bond. Because of the introduction of oxygen atoms, thermal motion of a polymer is reduced. Therefore, holes which are capable of selective permeation of a large amount of gas are generated. Accordingly, high gas separation selectivity can be obtained unlike the resin layer (a polydimethylsiloxane film 11 which has not been subjected to an ultraviolet ozone treatment step as illustrated in FIG. 6A) before the surface is treated.

A polydimethylsiloxane film into which oxygen atoms have been uniformly introduced in the film thickness direction as illustrated in FIG. 6C can be prepared using a chemical vapor deposition (CVD) method or the like without a gradation having oxygen atoms being introduced in the film thickness direction. In a case where such a film is compared to the resin layer 3 of the gas separation membrane of the present invention, the portion into which oxygen atoms have been densely introduced into the resin layer 3 of the gas separation membrane of the present invention is thinner than a polydimethylsiloxane film 12 into which oxygen atoms have been uniformly introduced in the film thickness direction. It is difficult for the polydimethylsiloxane film into which oxygen atoms have been uniformly introduced in the film thickness direction to be made thin similar to the thickness of the portion into which oxygen atoms have been densely introduced in the resin layer 3 of the gas separation membrane of the present invention. Therefore, extremely high gas permeability and gas separation selectivity can be achieved by the present invention.

Further, the gas separation membrane of the present invention can be designed such that the gas permeability is greatly increased and the gas separation selectivity is decreased. In addition, the gas separation membrane of the present invention can be also designed such that the gas permeability is decreased and the gas separation selectivity is greatly increased. Even in these cases, the gas separation selectivity of the gas separation membrane of the present invention is higher than that of a gas separation membrane of the related art in a case where the gas separation membrane is designed to have performance of gas permeability similar to the performance of gas permeability of the gas separation membrane of the related art and the gas permeability of the gas separation membrane of the present invention is higher than that of the gas separation membrane of the related art in a case where the gas separation membrane is designed to have performance of gas separation selectivity similar to the performance of gas separation selectivity of the gas separation membrane of the related art.

The performance of the gas separation membrane is considered to be determined according to the size of a hole in the plane of the layer contributing the gas separation, but this mechanism is not practical because it takes time and expenses for the operation of specifying the size of a hole even using an electron microscope. It was found that the gas separation membrane produced according to the method of producing a gas separation membrane of the present invention has excellent performance. The ultraviolet ozone treatment step can be expected to be replaced with a method of providing the same energy as the ultraviolet ozone treatment.

Hereinafter, preferred embodiments of the gas separation membrane of the present invention will be described.

<Configuration>

It is preferable that the gas separation membrane of the present invention is a thin layer composite membrane (also referred to as a gas separation composite membrane) or an asymmetric membrane or is formed of hollow fibers. Among these, a thin layer composite membrane is more preferable.

It is preferable that the gas separation membrane of the present invention has a roll shape.

Hereinafter, a case where the gas separation membrane is a thin layer composite membrane will be described as a typical example, but the gas separation membrane of the present invention is not limited to this thin layer composite membrane.

A preferred configuration of the gas separation membrane of the present invention will be described with reference to the accompanying drawings.

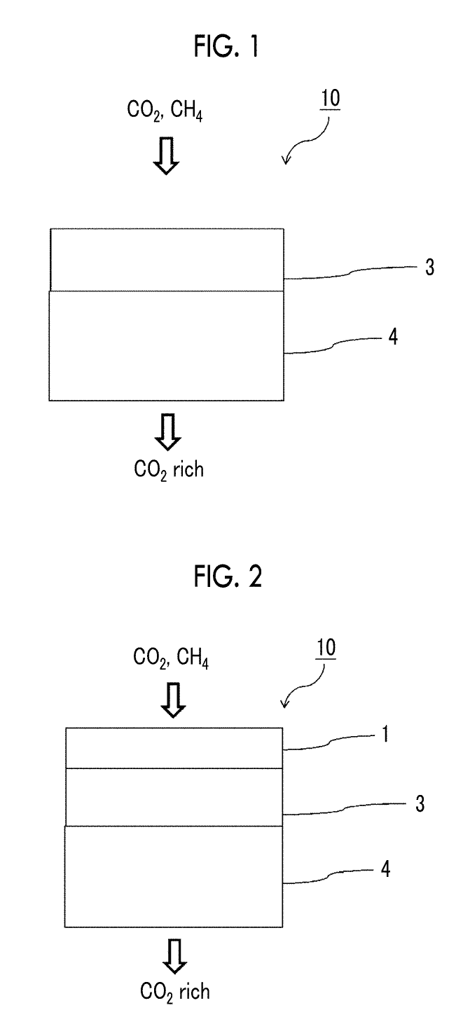

An example of the gas separation membrane 10 of the present invention illustrated in FIG. 1 is a gas separation membrane which is a thin layer composite membrane and includes the support 4 and the resin layer 3.

Another example of the gas separation membrane 10 of the present invention which is illustrated in FIG. 2 further includes an additional resin layer 1 described below on a side of the resin layer 3 opposite to a side where the support 4 is provided, in addition to the support 4 and the resin layer 3.

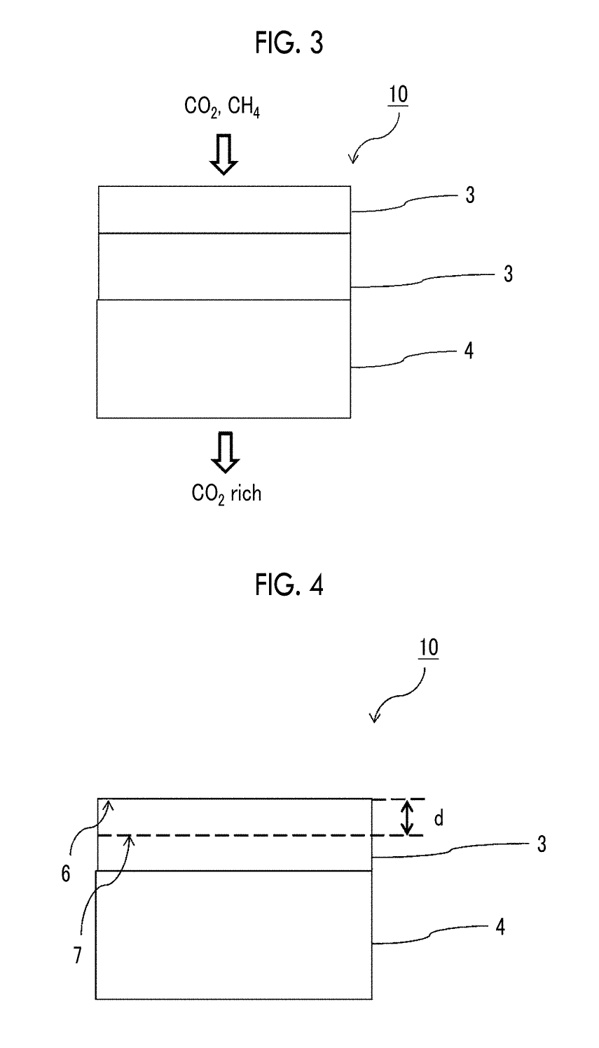

The gas separation membrane of the present invention may have only one or two or more resin layers. The gas separation membrane of the present invention has preferably one to five resin layers, more preferably one to three resin layers, still more preferably one or two layers from the viewpoint of the production cost, and particularly preferably only one layer. Another example of the gas separation membrane 10 of the present invention illustrated in FIG. 3 has two resin layers 3.

The expression “on the support” in the present specification means that another layer may be interposed between the support and a layer having a separation selectivity. Further, in regard to the expressions related to up and down, the direction in which a gas to be separated is supplied to is set as “up” and the direction in which the separated gas is discharged is set as “down” as illustrated in FIG. 1 unless otherwise specified.

The resin layer will be described with reference to FIG. 4. In FIG. 4, the surface of the resin layer 3 is denoted by the reference numeral 6.

In FIG. 4, in a case where a depth d is in a range of 4 to 10 nm, the surface parallel with the “surface 6 of the resin layer” at a depth of 4 to 10 nm (in the direction of the support) from the surface of the resin layer 3 is a “surface of a resin layer at a depth of 4 to 10 nm (in the direction of the support) from the surface of the resin layer” which is represented by the reference numeral 7.

<Support>

It is preferable that the gas separation membrane of the present invention includes a support and more preferable that the resin layer is formed on the support. From the viewpoint that the gas permeability can be sufficiently ensured, it is preferable that the support is thin and is formed of a porous material.

The gas separation membrane of the present invention may be obtained by forming and disposing the resin layer 3 on or in the surface of the porous support or may be a thin layer composite membrane conveniently obtained by forming the resin layer on the surface thereof. In a case where the resin layer 3 is formed on the surface of the porous support, a gas separation membrane with an advantage of having a high gas separation selectivity, a high gas permeability, and mechanical strength at the same time can be obtained.

In a case where the gas separation membrane of the present invention is a thin layer composite membrane, it is preferable that the thin layer composite membrane is formed by coating (the term “coating” in the present specification includes a form made by a coating material being adhered to a surface through immersion) the surface of the porous support with a coating solution (dope) that forms the resin layer 3. Specifically, it is preferable that the support has a porous layer on the side of the resin layer 3 and more preferable that the support is a laminate formed of non-woven fabric and a porous layer disposed on the side of the resin layer 3.

The material of the porous layer which is preferably applied to the support is not particularly limited and may be an organic or inorganic material as long as the material satisfies the purpose of providing mechanical strength and high gas permeability. A porous membrane of an organic polymer is preferable as the porous layer, and the thickness thereof is preferably in a range of 1 to 3000 μm, more preferably in a range of 5 to 500 μm, and still more preferably in a range of 5 to 150 μm. In regard to the pore structure of the porous layer, the average pore diameter is 10 μm or less, preferably 0.5 μm or less, and more preferably 0.2 μm or less. The porosity is preferably in a range of 20% to 90% and more preferably in a range of 30% to 80%. Further, the molecular weight cut-off of the porous layer is preferably 100,000 or less. Moreover, the gas permeability is preferably 3×10⁻⁵ cm³ (STP)/cm²·cm·sec·cmHg (30 GPU) or greater in terms of the permeation rate of carbon dioxide. STP is an abbreviation standing for standard temperature and pressure, and GPU is an abbreviation standing for gas permeation unit. Examples of the material of the porous layer include known polymers of the related art, for example, various resins such as a polyolefin resin such as polyethylene or polypropylene; a fluorine-containing resin such as polytetrafluoroethylene, polyvinyl fluoride, or polyvinylidene fluoride; polystyrene, cellulose acetate, polyurethane, polyacrylonitrile, polyphenylene oxide, polysulfone, polyether sulfone, polyimide, and polyaramid. As the shape of the porous layer, any of a flat shape, a spiral shape, a tubular shape, and a hallow fiber shape can be employed.

In the thin layer composite membrane, it is preferable that woven fabric, non-woven fabric, or a net used to provide mechanical strength is provided in the lower portion of the porous layer disposed on the side of the resin layer 3. In terms of film forming properties and the cost, non-woven fabric is suitably used. As the non-woven fabric, fibers formed of polyester, polypropylene, polyacrylonitrile, polyethylene, and polyamide may be used alone or in combination of plural kinds thereof. The non-woven fabric can be produced by papermaking main fibers and binder fibers which are uniformly dispersed in water using a circular net or a long net and then drying the fibers with a dryer. Moreover, for the purpose of removing a nap or improving mechanical properties, it is preferable that thermal pressing processing is performed on the non-woven fabric by interposing the non-woven fabric between two rolls.

<Resin Layer Containing Compound Having Siloxane Bond>

The gas separation membrane of the present invention includes a resin layer containing a compound having a siloxane bond, and the compound having a siloxane bond contained in the resin layer has at least a repeating unit represented by Formula (2) or a repeating unit represented by Formula (3).

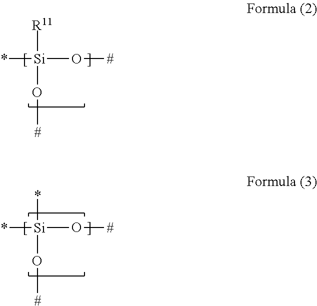

In Formulae (2) and (3), R¹¹ represents a substituent, the symbol “*” represents a bonding site with respect to # in Formula (2) or (3), and the symbol “#” represents a bonding site with respect to * in Formula (2) or (3).

In a case where a resin layer is formed using such a compound having a siloxane bond, it is possible to exhibit high gas permeability and gas separation selectivity under a high pressure.

Further, a case where a resin layer is formed by performing the ultraviolet ozone treatment on the resin layer precursor will be described. It is not intended to adhere to any theory, but it is considered that the oxygen atoms formed by the ultraviolet ozone treatment enter not only the surface of the resin layer but also the inside of the resin layer in the thickness direction to form the composition of SiOx. As the result, it is considered that high gas permeability and high gas separation selectivity are exhibited under a high pressure. Particularly, even in a case where polydimethylsiloxane known to have a high gas permeability is used as a component of the resin layer precursor, high gas permeability and high separation selectivity under a high pressure can be exhibited by forming a resin layer. The surface of the resin layer and the resin layer are formed by the oxygen atoms entering not only the surface of the resin layer but also the inside thereof in the thickness direction. It is preferable that, inside the resin layer in the thickness direction, the compound having a siloxane bond has at least a repeating unit represented by Formula (2) or a repeating unit represented by Formula (3).

R¹¹ in Formula (2) represents preferably a hydroxyl group, an alkyl group having 1 or more carbon atoms, an aryl group, an amino group, an epoxy group, or carboxyl group. R¹¹ in Formula (2) represents more preferably a hydroxyl group, an alkyl group having 1 or more carbon atoms, an amino group, an epoxy group, or a carboxyl group and more preferably a hydroxyl group, an alkyl group having 1 or more carbon atoms, an epoxy group, or a carboxyl group.

The hydroxyl group or the carboxyl group as R¹¹ in Formula (2) may form an optional salt.

In Formulae (2) and (3), the symbol “*” represents a bonding site with respect to # in Formula (2) or (3), and the symbol “#” represents a bonding site with respect to * in Formula (2) or (3). Further, the symbol “*” may represent a bonding site with respect to an oxygen atom in Formula (1) and the symbol “#” may represent a bonding site with respect to a silicon atom in Formula (1).

In the gas separation membrane of the present invention, it is preferable that the compound having a siloxane bond contained in the resin layer has a repeating unit represented by Formula (1).

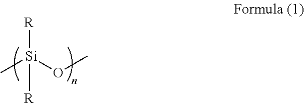

In Formula (1), R's each independently represent a hydrogen atom, an alkyl group having 1 or more carbon atoms, an aryl group, an amino group, an epoxy group, a fluorinated alkyl group, a vinyl group, an alkoxy group, or a carboxyl group, and n represents an integer of 2 or greater.

In Formula (1), R's each independently represent preferably an alkyl group having 1 or more carbon atoms, an aryl group, an amino group, an epoxy group, or a carboxyl group, more preferably an alkyl group having 1 or more carbon atoms, an amino group, an epoxy group, or a carboxyl group, and still more preferably an alkyl group having 1 or more carbon atoms, an epoxy group, or a carboxyl group.

The alkyl group having 1 or more carbon atoms which is represented by R in Formula (1) is preferably an alkyl group having 1 to 10 carbon atoms, more preferably a methyl group, an ethyl group, or a propyl group, and still more preferably a methyl group. The alkyl group having 1 or more carbon atoms which is represented by R may be linear, branched, or cyclic.

The aryl group represented by R in Formula (1) is preferably an aryl group having 6 to 20 carbon atoms and particularly preferably a phenyl group.

The fluorinated alkyl group represented by R in Formula (1) is preferably a fluorinated alkyl group having 1 to 10 carbon atoms, more preferably a fluorinated alkyl group having 1 to 3 carbon atoms, and particularly preferably a trifluoromethyl group. The fluorinated alkyl group represented by R may be linear, branched, or cyclic.

The alkoxy group represented by R in Formula (1) is preferably an alkoxy group having 1 to 10 carbon atoms, more preferably a methoxy group, an ethoxy group, or a propyloxy group, and particularly preferably a methoxy group. The alkoxy group having 1 or more carbon atoms which is represented by R may be linear, branched, or cyclic.

In Formula (1), n represents an integer of 2 or greater, preferably in a range of 40 to 800, more preferably in a range of 50 to 700, and particularly preferably in a range of 60 to 500.

The compound having a siloxane bond which has a repeating unit represented by Formula (1) may include an optional substituent in the terminal of a molecule other than the repeating unit represented by Formula (1). Examples and preferable ranges of the substituent which may be included in the terminal of a molecule of the compound having a siloxane bond which includes a repeating unit represented by Formula (1) are the same as the examples and preferable ranges of R in Formula (1).

In the gas separation membrane of the present invention, it is preferable that the surface of the resin layer described above contains a compound having a siloxane bond which includes a repeating unit represented by Formula (1) and at least a repeating unit represented by Formula (2) or a repeating unit represented by Formula (3).

It can be confirmed that the surface of the resin layer and the resin layer at a depth of 4 to 10 nm from the surface contain a compound having a siloxane bond having repeating units represented by Formulae (1) to (3) using the following method.

The Si 2p spectrum on the surface of the resin layer is measured using electron spectroscopy for chemical analysis (ESCA), and the valence of Si (Si²⁺, Si³⁺, and Si⁴⁺) is separated and quantified from the curve fitting of obtained peaks.

It is preferable that the compound having a siloxane bond used for the resin layer has a functional group which can be polymerized. Examples of such a functional group include an epoxy group, an oxetane group, a carboxyl group, an amino group, a hydroxyl group, and a thiol group. It is more preferable that the resin layer includes an epoxy group, an oxetane group, a carboxyl group, and a compound having a siloxane bond which includes two or more groups among these groups. It is preferable that such a resin layer is formed by being cured by irradiating a radiation-curable composition on the support with radiation.

The compound having a siloxane bond which is used for the resin layer may be polymerizable dialkylsiloxane formed from a partially cross-linked radiation-curable composition having a dialkylsiloxane group. Polymerizable dialkylsiloxane is a monomer having a dialkylsiloxane group, a polymerizable oligomer having a dialkylsiloxane group, or a polymer having a dialkylsiloxane group. As the dialkylsiloxane group, a group represented by —{O—Si(CH₃)₂}ₙ₂— (n2 represents a number of 1 to 100) can be exemplified. A poly(dialkylsiloxane) compound having a vinyl group at the terminal can be preferably used.

Commercially available materials can be used as the compound having a siloxane bond contained in the resin layer precursor. Preferred examples of the compound include UV9300 (polydimethylsiloxane (PDMS), manufactured by Momentive Performance Materials Inc.) and X-22-162C (manufactured by Shin-Etsu Chemical Co., Ltd.). Among these, UV9300 can be more preferably used.

UV9380C (bis(4-dodecylphenyl)iodonium hexafluoroantimonate, manufactured by Momentive Performance Materials Inc.) can be preferably used as other components contained in the resin layer precursor.

The material of the resin layer precursor can be prepared as a composition including an organic solvent at the time of formation of the resin layer, and it is preferable that the material thereof is a curable composition. The organic solvent which can be used at the time of formation of the resin layer is not particularly limited, and examples thereof include n-heptane.

In the present specification, the ratio of the number of oxygen atoms to the number of silicon atoms in each surface of the resin layer can be measured as a relative amount. In other words, a O/Si ratio (A) which is a ratio of the number of oxygen atoms to the number of silicon atoms of the resin layer at a depth of 4 to 10 nm from the surface of the resin layer can be measured as a O/Si ratio (B) which is a ratio of the number of oxygen atoms to the number of silicon atoms in the surface of the resin layer.

The O/Si ratio (A) which is a ratio of the number of oxygen atoms to the number of silicon atoms contained in the resin layer at a depth of 4 to 10 nm from the surface of the resin layer and the O/Si ratio (B) which is a ratio of the number of oxygen atoms to the number of silicon atoms in the surface of the resin layer are calculated using ESCA. A C/Si ratio which is a ratio of the number of carbon atoms to the number of silicon atom in the surface of the resin layer can also be calculated in the same manner as described above.

The O/Si ratio (B) which is a ratio of the number of oxygen atoms to the number of silicon atoms in the surface of the resin layer is calculated by putting the porous support on which the resin layer is formed into Quantera SXM (manufactured by Physical Electronics, Inc.) under the following conditions of using Al-Kα rays (1,490 eV, 25 W, diameter of 100 μm) as an X-ray source with Pass Energy of 55 eV and Step of 0.05 eV in a measuring region having a size of 300 μm×300 μm.

Next, in order to acquire the O/Si ratio (A) which is a ratio of the number of oxygen atoms to the number of silicon atoms contained in the resin layer at a depth of 4 to 10 nm from the surface of the resin layer, etching is performed using C₆₀ ions.

Specifically, the ion beam intensity is set to C₆₀⁺ of 10 KeV and a region having a size of 2 mm×2 mm as 10 nA is etched by 4 to 10 nm using a C₆₀ ion gun belonging to Quantera SXM (manufactured by Physical Electronics, Inc.). With this membrane, the O/Si ratio (A) which is a ratio of the number of oxygen atoms to the number of silicon atoms in the surface of the resin layer is calculated using an ESCA device. The depth of the resin layer from the surface thereof is calculated at an etching rate of 10 nm/min of the material of the resin layer. As this value, an optimum numerical value is appropriately used depending on the material.

The value of AB is calculated based on the O/Si ratio (A) which is a ratio of the number of oxygen atoms to the number of silicon atoms of the resin layer at a depth of 4 to 10 nm from the surface of the obtained resin layer and the O/Si ratio (B) which is a ratio of the number of oxygen atoms to the number of silicon atoms in the surface of the resin layer.

In the present specification, the surface of the resin layer is a surface which has a maximum 0/Si ratio in a case where the O/Si ratio is measured from the surface (preferably a surface on the opposite side of the support) of the gas separation membrane and contains 3% (atomic %) or greater of silicon atoms.

In a case where the surface of the resin layer does not have another layer, the surface having a maximum 0/Si ratio in a case where the O/Si ratio is measured from the surface of the gas separation membrane using the following method, which is the same method as the method of acquiring the O/Si ratio (A) that is a ratio of the number of oxygen atoms to the number of silicon atoms of the resin layer at a depth of 4 to 10 nm from the surface of the resin layer, and containing 3% (atomic %) or greater of silicon atoms is specified.

As the result, according to the above-described method, it is confirmed that the surface of the resin layer in a state in which the resin layer is formed on the porous support (in a state without another layer (for example, a protective layer)) is a “surface which has a maximum 0/Si ratio in a case where the O/Si ratio is measured from the surface of the gas separation membrane and contains 3% (atomic %) or greater of silicon atoms”.

In a case where the surface of the resin layer has another layer (for example, a protective layer), the surface of the resin layer (that is, the surface which has the maximum 0/Si ratio in a case where the O/Si ratio is measured from the surface of the gas separation membrane and contains 3% (atomic %) or greater of silicon atoms) is acquired using the following method, which is the same method as the method of acquiring the O/Si ratio (A) that is a ratio of the number of oxygen atoms to the number of silicon atoms of the resin layer at a depth of 4 to 10 nm from the surface of the resin layer.

As the result, according to the above-described method, the surface of the resin layer in a state in which the resin layer is formed on the porous support (in a state without another layer (for example, a protective layer)) is the “surface which has a maximum 0/Si ratio in a case where the O/Si ratio is measured from the surface of the gas separation membrane and contains 3% (atomic %) or greater of silicon atoms”. Specifically, the “surface of the resin layer in a state in which the resin layer is formed on the porous support (in a state without another layer (for example, a protective layer))” is the “surface which has a maximum 0/Si ratio in a case where the O/Si ratio is measured from the surface of the gas separation membrane and contains 3% (atomic %) or greater of silicon atoms”.

In the gas separation membrane, the resin layer which satisfies the above-described expression is present in the plane thereof by preferably 50% or greater, more preferably 70% or greater, and still more preferably 90% or greater.

Another region other than the resin layer which satisfies the above-described expression may be present in the plane of the gas separation membrane. Examples of another region include a region for which an adhesive or a pressure sensitive adhesive is provided and a region in which the resin layer is not sufficiently subjected to an ultraviolet ozone treatment.

The resin layer contains a compound having a siloxane bond. The compound having a siloxane bond may be a “compound which includes a repeating unit having at least silicon atoms, oxygen atom, and carbon atoms”. Further, the compound having a siloxane bond may be a “compound having a siloxane bond and a repeating unit”, and a compound having a polysiloxane bond is preferable.

The thickness of the resin layer is not particularly limited. From the viewpoint of ease of film formation, the thickness of the resin layer described above is preferably 0.1 μm or greater, more preferably in a range of 0.4 to 5 μm, still more preferably in a range of 0.4 to 4 μm, and particularly preferably in a range of 0.4 to 3 μm. The thickness of the resin layer can be acquired using an SEM.

The thickness of the resin layer can be controlled by adjusting the coating amount of a composition for forming a resin layer precursor.

<Additional Resin Layer>

Examples of the resin contained in the additional resin layer are described below, but are not limited thereto. Specifically, the compound having a siloxane bond, polyimides, polyamides, celluloses, polyethylene glycols, and polybenzoxazoles are preferable and at least one selected from the compound having a siloxane bond, polyimide, polybenzoxazole, and acetic acid cellulose is more preferable. It is preferable that the gas separation membrane of the present invention includes the resin layer described above and further includes a layer containing a polyimide compound as the additional resin layer.

Polyimide Having a Reactive Group is Preferable as the Polyimide Compound.

The aspect of the preferable additional resin layer in a case where the resin of the additional resin layer is polyimide having a reactive group is the same as the preferred aspect of the separation layer described in paragraphs <0039> to <0070> of JP2015-160201A, and this publication is incorporated herein by reference.

In addition, the resin of the additional resin layer other than polyimide can be selected from celluloses such as cellulose acetate, cellulose triacetate, cellulose acetate butyrate, cellulose propionate, ethyl cellulose, methyl cellulose, and nitrocellulose. As the celluloses which can be used for the additional resin layer, it is preferable that the degree of substitution of all acyl groups is in a range of 2.0 to 2.7. Cellulose acetate L-40 (degree of substitution of acyl groups: 2.5, manufactured by Daicel Corporation) which is commercially available as a product of cellulose acetate can be preferably used.

As other resins of the additional resin layer, polyethylene glycols such as a polymer obtained by polymerizing polyethylene glycol #200 diacrylate (manufactured by Shin-Nakamura Chemical Co., Ltd.); and a polymer described in JP2010-513021A can be selected.

Another additional resin layer may be interposed between the support and the resin layer. As another additional resin layer, polyvinyl alcohol (PVA) may be exemplified.

It is preferable that the film thickness of the additional resin layer is as small as possible under the conditions of imparting high gas permeability while maintaining the mechanical strength and gas separation selectivity.

From the viewpoint of improving the gas permeability, it is preferable that the additional resin layer other than the resin layer of the gas separation membrane of the present invention is a thin layer. The thickness of the additional resin layer other than the resin layer is typically 10 μm or less, preferably 3 μm or less, more preferably 1 μm or less, still more particularly preferably 0.3 μm or less, and particularly preferably 0.2 μm or less.

Further, the thickness of the additional resin layer is typically 0.01 μm or greater, preferably 0.03 μm or greater from the practical viewpoint that film formation is easily carried out, and more preferably 0.1 μm or greater.

<Protective Layer>

The gas separation membrane may include a protective layer formed on the resin layer or the additional resin layer. The protective layer is a layer disposed on the resin layer or the additional resin layer. At the time of handling or use, unintended contact between the resin layer or the additional resin layer and other materials can be prevented.

The material of the protective layer is not particularly limited, but the preferable ranges of the material used for the protective layer are the same as the preferable ranges of the material used for the resin layer. Particularly, it is preferable that the protective layer is at least one selected from polydimethylsiloxane, poly(l-trimethylsilyl-1-propyne), and polyethylene oxide, more preferable that the protective layer is polydimethylsiloxane or poly(l-trimethylsilyl-1-propyne), and still more preferable that the protective layer is polydimethylsiloxane.

The film thickness of the protective layer is preferably in a range of 20 nm to 3 μm, more preferably in a range of 50 nm to 2 μm, and particularly preferably in a range of 100 nm to 1 μm.

<Characteristics and Applications>

The gas separation membrane of the present invention can be suitably used according to a gas separation recovery method and a gas separation purification method. For example, a gas separation membrane which is capable of efficiently separating specific gas from a gas mixture containing gas, for example, hydrogen, helium, carbon monoxide, carbon dioxide, hydrogen sulfide, oxygen, nitrogen, ammonia, a sulfur oxide, or a nitrogen oxide; hydrocarbon such as methane, or ethane; unsaturated hydrocarbon such as propylene; or a perfluoro compound such as tetrafluoroethane can be obtained.

It is preferable that the gas separation membrane of the present invention is used to separate at least one kind of acidic gas from a gas mixture of acidic gas and non-acidic gas. Examples of the acidic gas include carbon dioxide, hydrogen sulfide, carbonyl sulfide, a sulfur oxide (SOx), and a nitrogen oxide (NOx). Among these, at least one selected from carbon dioxide, hydrogen sulfide, carbonyl sulfide, a sulfur oxide (SOx), and a nitrogen oxide (NOx) is preferable; carbon dioxide, hydrogen sulfide, or a sulfur oxide (SOx) is more preferable; and carbon dioxide is particularly preferable.

As the non-acidic gas, at least one selected from hydrogen, methane, nitrogen, and carbon monoxide is preferable; methane or hydrogen is more preferable, and methane is still more preferable.

It is preferable that the gas separation membrane of the present invention selectively separates carbon dioxide from the gas mixture including particularly carbon dioxide and hydrocarbon (methane).

In addition, in a case where gas subjected to a separation treatment is mixed gas of carbon dioxide and methane, the permeation rate of the carbon dioxide at 30° C. and 5 MPa is preferably 10 GPU or greater, more preferably in a range of 10 to 300 GPU, and still more preferably in a range of 15 to 300 GPU.

Further, 1 GPU is 1×10⁻⁶ cm³(STP)/cm²·sec·cmHg.

In the case where the gas separation membrane of the present invention is a membrane in which the gas subjected to a separation treatment is mixed gas of carbon dioxide and methane, a gas separation selectivity a which is a ratio of the permeation flux of carbon dioxide at 30° C. and 5 MPa to the permeation flux of methane is preferably 30 or greater, more preferably 35 or greater, particularly preferably 40 or greater, and more particularly preferably greater than 50.

It is considered that a mechanism of dissolution and diffusion in a membrane is involved in the selective gas permeation. From this viewpoint, a separation membrane including a polyethyleneoxy (PEO) composition is examined (see Journal of Membrane Science, 160 (1999), p. 87 to 99). This is because interaction between carbon dioxide and the polyethyleneoxy composition is strong. Since this polyethyleneoxy film is a flexible rubber-like polymer film having a low glass transition temperature, a difference in the diffusion coefficient resulting from the kind of gas is small and the gas separation selectivity is mainly due to the effect of a difference in solubility. Meanwhile, the preferred embodiments of the present invention can be significantly improved from the viewpoints of the high glass transition temperature of the compound having a siloxane bond contained in the resin layer and the thermal durability of the membrane while the above-described action of dissolution and diffusion is exhibited.

<Method of Separating Gas Mixture>

Using the gas separation membrane of the present invention, it is possible to perform separation of a gas mixture.

In the method of separating a gas mixture used for the gas separation membrane of the present invention, the components of the gas mixture of raw materials are affected by the production area of the raw materials, the applications, or the use environment and are not particularly defined. According to the method of separation gas mixture used for the gas separation membrane of the present invention, it is preferable that the main components of the gas mixture are carbon dioxide and methane, carbon dioxide and nitrogen, or carbon dioxide and hydrogen.

In other words, the proportion of carbon dioxide and methane or carbon dioxide and hydrogen in the gas mixture is preferably in a range of 5% to 50% and more preferably in a range of 10% to 40% in terms of the proportion of carbon dioxide. In a case where the gas mixture is present in the coexistence of an acidic gas such as carbon dioxide or hydrogen sulfide, the method of separating the gas mixture using the gas separation membrane of the present invention exhibits particularly excellent performance. According to the method of separation gas mixture used for the gas separation membrane of the present invention, preferably, the method thereof exhibits excellent performance at the time of separating carbon dioxide and hydrocarbon such as methane, carbon dioxide and nitrogen, or carbon dioxide and hydrogen.

It is preferable that the method of separating a gas mixture includes a process of allowing carbon dioxide to selectively permeate from mixed gas including carbon dioxide and methane. The pressure during gas separation is preferably in a range of 3 MPa to 10 MPa, more preferably in a range of 4 MPa to 7 MPa, and particularly preferably in a range of 5 MPa to 7 MPa. Further, the temperature during gas separation is preferably in a range of −30° C. to 90° C. and more preferably in a range of 15° C. to 70° C.

[Gas Separation Membrane Module and Gas Separator]

A gas separation membrane module of the present invention includes the gas separation membrane of the present invention.

It is preferable that the gas separation membrane of the present invention is used for a thin layer composite membrane obtained by combining with a porous support and also preferable that the gas separation membrane is used for a gas separation membrane module using this thin layer composite membrane. Further, using the gas separation membrane, the thin layer composite membrane, or the gas separation membrane module of the present invention, a gas separator having means for performing separation and recovery of gas or performing separation and purification of gas can be obtained. The gas separation membrane of the present invention can be made into a module and suitably used. Examples of the module include a spiral type module, a hollow fiber type module, a pleated module, a tubular module, and a plate & frame type module. The gas separation membrane of the present invention may be applied to a gas separation and recovery apparatus which is used together with an absorption liquid described in JP2007-297605A according to a membrane/absorption hybrid method.

### EXAMPLES

The characteristics of the present invention will be described in detail with reference to examples and comparative examples (the comparative examples do not correspond to known techniques) described below. The materials, the amounts to be used, the ratios, the treatment contents, and the treatment procedures shown in the examples described below can be appropriately changed as long as it is within the gist of the present invention. Accordingly, the scope of the present invention should not be limitatively interpreted by the specific examples described below.

Moreover, “part” and “%” in the sentences are on a mass basis unless otherwise noted.

### Examples 1 to 6 and Comparative Examples 1 to 6

<Silicone Coating Solution>

A material containing a silicone resin (UV9300, manufactured by Momentive Performance Materials Inc.) was prepared in order to form a resin layer. 0.5% by mass of 4-isopropyl-4′-methyldiphenyliodonium tetrakis(pentafluorophenyl)borate (manufactured by Tokyo Chemical Industry Co., Ltd.) was added to the silicone resin as a curing agent, thereby preparing a silicone coating solution.

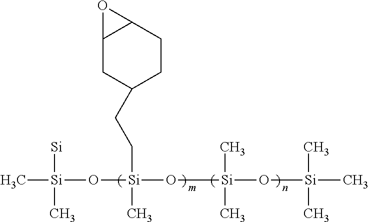

The viscosity of the silicone coating solution (the silicone coating solution to which the curing agent was added) at 25° C. was measured by utilizing a spindle No. M4 as a rotor at a rotation speed of 60 rounds per minute (rpm) with TVB-10M (manufactured by TOKI SANGYO CO., LTD.) in conformity with JIS Z8803 and measuring the value after 30 seconds from the initiation of the rotation as the viscosity of the silicone coating solution. As the result, the viscosity of the silicone coating solution at 25° C. was 300 mPa·s.

<Support>

A support roll formed by winding a long porous support having a width of 500 mm and a thickness of 200 μm in a roll shape was prepared. Further, as the support, a laminate formed by laminating porous polyacrylonitrile (PAN) serving as a porous membrane on a surface of polyethylene terephthalate (PET) non-woven fabric serving as an auxiliary support membrane was used.

The maximum pore size of the porous membrane in this support was measured using a palm porometer, and the value was 0.10 μm.

<Preparation of Composite>

A support roll was mounted on the rotating shaft of the supply unit in the producing device illustrated in FIG. 7 such that the porous membrane side was coated with the silicone coating solution. Next, the support was sent out from the support roll, and the tip of the support was wound around the winding shaft after the support passed through the coating unit, the curing device, and a predetermined transport path reaching the winding unit, as described above.

In addition, the coating device of the coating unit was filled with the silicone coating solution. Further, in the coating device, the temperature of the silicone coating solution filling the coating device was controlled such that the temperature thereof was set to be in a range of 24° C. to 25° C.

After the above-described preparation was completed, transport of the support was started, a surface of the porous membrane was coated with the silicone coating solution by the coating unit as described above, the surface was irradiated with ultraviolet rays by the curing device, the silicone coating solution was cured, and a composite obtained by forming a resin layer precursor on the support was obtained. Further, the prepared composite was wound around the winding shaft to form a composite roll.

The transport speed of the support was set to 50 m/min. Further, after the silicone coating solution was applied, the position to be irradiated with ultraviolet rays and the irradiation dose in the curing device were adjusted such that the silicone coating solution was cured in 2 seconds.

The silicone coating solution was applied such that the thickness of the resin layer precursor was set to 0.6 μm. In addition, the composite was cut at an optional site, the cross section was observed using a scanning electron microscope, and the thickness (average value) of the resin layer precursor infiltrated into the porous membrane was measured by analyzing an energy dispersive X-ray analysis image of the cross section. The ratio ((thickness of silicone resin in porous membrane)/(thickness of resin layer precursor)) was 0.9.

Further, after the silicone coating solution was applied, the relationship between the time taken until the silicone coating solution was cured and the irradiation dose of ultraviolet rays, the film thickness of the resin layer, and the coating amount of the silicone coating solution were examined by experiments in advance.

<Ultraviolet Ozone Treatment Method>

(Exposure in Roll-to-Roll Step Separately from Irradiation of Resin Layer Precursor with Ultraviolet Rays)

A step of disposing the composite obtained by forming the resin layer precursor on the support and unwinding the composite from the roll, an ultraviolet ozone treatment step, and a step of winding the composite around the roll were performed on a producing device 50 having a roll-to-roll system provided with an ultraviolet ozone treatment device 80 illustrated in FIG. 8. In the ultraviolet ozone treatment step, light containing ultraviolet rays with a wavelength of 185 nm and ultraviolet rays with a wavelength of 254 nm was applied. Each illuminance was set to 3.5 mW/cm² (ultraviolet rays having a wavelength of 185 nm) and 68 mW/cm² (ultraviolet rays having a wavelength of 254 nm), and the cumulative irradiation doses were changed to values listed in Table 1 by changing the transport speed corresponding to the irradiation time. Further, the ultraviolet ozone treatment step was performed at an atmospheric pressure in an air atmosphere environment or in an oxygen flow (1.0 L/min of oxygen was allowed to flow to the support having a width of 500 mm) atmosphere environment listed in Table 1.

In a case where light having only a wavelength of 254 nm was applied, quartz glass was disposed under a low-pressure mercury lamp performing irradiation with light containing ultraviolet rays having a wavelength of 254 nm and ultraviolet rays having a wavelength of 185 nm, and the wavelength of 240 nm or less was cut.

The obtained gas separation membranes were respectively set as the gas separation membranes of Examples 1 to 6 and Comparative Examples 1 to 6.

<Composition of Resin Layer Containing Compound Having Siloxane Bond>

The central portion of the porous support forming the resin layer after the ultraviolet ozone treatment step was sampled. The O/Si ratio (A) as a ratio of the number of oxygen atoms to the number of silicon atoms contained in the resin layer at a depth of 4 to 10 nm from the surface of the resin layer and the O/Si ratio (B) as a ratio of the number of oxygen atoms to the number of silicon atoms in the surface of the resin layer were calculated using ESCA.

The O/Si ratio (B) as a ratio of the number of oxygen atoms to the number of silicon atoms in the surface of the resin layer was calculated by putting the porous support on which the resin layer was formed into Quantera SXM (manufactured by Physical Electronics, Inc.) under the following conditions of using Al-Kα rays (1,490 eV, 25 W, diameter of 100 μm) as an X-ray source with Pass Energy of 55 eV and Step of 0.05 eV in a measuring region having a size of 300 μm×300 μm. A C/Si ratio as a ratio of the number of carbon atoms to the number of silicon atom in the surface of the resin layer was also calculated in the same manner as described above.

Next, in order to acquire the O/Si ratio (A) as a ratio of the number of oxygen atoms to the number of silicon atoms contained in the resin layer at a depth of 4 to 10 nm from the surface of the resin layer, etching was performed using C₆₀ ions. In other words, the ion beam intensity was set to C₆₀⁺ of 10 KeV and a region having a size of 2 mm×2 mm as 10 nA was etched by 4 to 10 nm using a C₆₀ ion gun belonging to Quantera SXM (manufactured by Physical Electronics, Inc.). With this membrane, the O/Si ratio (A) as a ratio of the number of oxygen atoms to the number of silicon atoms in the surface of the resin layer was calculated using an ESCA device. The depth of the resin layer from the surface thereof is calculated at an etching rate of 10 nm/min of the resin layer. This value was able to be acquired as the material was changed so that an optimum numerical value was appropriately used for the material.

The value of AB was calculated based on the O/Si ratio (A) as a ratio of the number of oxygen atoms to the number of silicon atoms of the resin layer at a depth of 4 to 10 nm from the surface of the obtained resin layer and the O/Si ratio (B) as a ratio of the number of oxygen atoms to the number of silicon atoms in the surface of the resin layer.

The surface of the resin layer described above was a surface having a maximum 0/Si ratio in a case where the O/Si ratio was measured from the surface of the gas separation membrane and containing 3% (atomic %) or greater of silicon atoms. The surface having a maximum 0/Si ratio in a case where the O/Si ratio was measured from the surface of the gas separation membrane and containing 3% (atomic %) or greater of silicon atoms was specified using the same method as the method of acquiring the O/Si ratio (A) as a ratio of the number of oxygen atoms to the number of silicon atoms of the resin layer at a depth of 4 to 10 nm from the surface of the resin layer.

As the result, according to the above-described method, it was confirmed that the surface of the resin layer in a state in which the resin layer was formed on the porous support (in a state without another layer (for example, a layer containing a polyimide compound)) was a “surface having a maximum 0/Si ratio in a case where the O/Si ratio was measured from the surface of the gas separation membrane and containing 3% (atomic %) or greater of silicon atoms”.

In the above-described manner, it was confirmed that the resin layer contains a compound having a repeating unit containing at least a silicon atom, an oxygen atom, and a carbon atom.

It was confirmed that the surface of the resin layer and the resin layer at a depth of 4 to 10 nm from the surface contain a compound having a siloxane bond having a repeating unit represented by Formula (1) and at least a repeating unit represented by Formula (2) or a repeating unit represented by Formula (3) according to the following method.

The Si 2p spectrum was measured using ESCA and the valence of Si (Si²⁺, Si³⁺, and Si⁴⁺) was separated and quantified from the curve fitting of obtained peaks.

[Evaluation]

<Gas Separation Performance>

The obtained gas separation membranes of the respective examples and the respective comparative examples were evaluated using SUS316 (SUS indicates Stainless Used Steel) STAINLESS STEEL CELL (manufactured by DENIS SEN Ltd.) having high pressure resistance after the temperature of a cell was adjusted to 30° C. The respective gas permeabilities of CO₂ and CH₄ were measured by TCD detection type gas chromatography by adjusting the total pressure on the gas supply side of mixed gas, in which the volume ratio of carbon dioxide (CO₂) to methane (CH₄) was set to 6:94, to 5 MPa (partial pressure of CO₂: 0.65 MPa). The gas separation selectivity of the gas separation membrane of each example and each comparative example was calculated as a ratio (P_{CO2}/P_{CH4}) of a permeability coefficient P_{CO2} of CO₂ to a permeability coefficient P_{CH4} of CH₄ of this membrane. The CO₂ gas permeability of the gas separation membrane of each example and each comparative example was set as a permeability Q_{CO2} (unit: GPU) of CO₂ of this membrane.

In a case where the gas permeability (permeability Q_{CO2} of CO₂) was 30 GPU or greater and the gas separation selectivity was 40 or greater, the gas separation performance was evaluated as AA.

In a case where the gas permeability (permeability Q_{CO2} of CO₂) was 10 GPU and the gas separation selectivity was 30 or greater and less than 40 or the gas permeability (permeability Q_{CO2} of CO₂) was 10 GPU or greater and less than 30 GPU and the gas separation selectivity was 40 or greater, the gas separation performance was evaluated as A.

In a case where the gas permeability (permeability Q_{CO2} of CO₂) was 10 GPU or greater and the gas separation selectivity was 10 or greater and less than 30 or the gas permeability (permeability Q_{O2} of CO₂) was less than 10 GPU and the gas separation selectivity was 30 or greater, the gas separation performance was evaluated as B.

In a case where the gas permeability (permeability Q_{CO2} of CO₂) was less than 10 GPU and the gas separation selectivity was less than 30, the gas permeability (permeability Q_{CO2} of CO₂) was 10 GPU or greater and the gas separation selectivity was less than 10, or the pressure was not able to be applied (the pressure was not able to be held) so that the test was not able to be performed, the gas separation performance was evaluated as C.

In addition, the unit of gas permeability was expressed by the unit of GPU [1 GPU=1×10⁻⁶ cm³ (STP)/cm²·sec·cmHg] representing the permeation flux (also referred to as permeation rate, permeability, and Permeance) per pressure difference or the unit of barrer [1 barrer=1×10⁻¹⁰ cm³ (STP)·cm/cm²·sec·cmHg] representing the permeation coefficient. In the present specification, the symbol Q is used to represent in a case of the unit of GPU and the symbol P is used in a case of the unit of barrer.

The obtained results are listed in Table 1.

TABLE 1

| | | Cumulative | Cumulative | |
|---|---|---|---|---|
| | | irradiation | irradiation | Gas |
| | | dose (J/cm²) | dose (J/cm²) | separation |
| | Atmosphere | 185 nm | 254 nm | performance |
| Comparative | Air | 5.3 | 102 | C |
| Example 1 | | | | |
| Comparative | Air | 18.9 | 367 | C |
| Example 2 | | | | |
| Comparative | Oxygen flow | 5.3 | 102 | C |
| Example 3 | | | | |
| Comparative | Oxygen flow | 18.9 | 367 | C |
| Example 4 | | | | |
| Comparative | Air | — | 224 | C |
| Example 5 | | | | |
| Comparative | Oxygen flow | — | 224 | C |
| Example 6 | | | | |
| Example 1 | Air | 6.3 | 120 | B |
| Example 2 | Air | 11.6 | 224 | A |
| Example 3 | Air | 16.8 | 327 | B |
| Example 4 | Oxygen flow | 6.3 | 120 | A |
| Example 5 | Oxygen flow | 11.6 | 224 | AA |
| Example 6 | Oxygen flow | 16.8 | 327 | A |

As listed in Table 1, it was understood that the gas separation membrane of the present invention produced according to the method of producing a gas separation membrane of the present invention has excellent gas separation performance. Specifically, it was understood that the gas separation membrane of the present invention produced according to the method of producing a gas separation membrane of the present invention had an excellent gas separation selectivity under a high pressure and an excellent productivity.

Meanwhile, as shown in Comparative Examples 1 and 3, it was understood that the gas separation membrane produced by performing the ultraviolet ozone treatment step under a condition in which the cumulative irradiation dose of ultraviolet rays having a wavelength of 185 nm and the cumulative irradiation dose of ultraviolet rays having a wavelength of 254 nm were respectively less than the lower limit defined in the present invention had poor gas separation performance. Further, based on Comparative Examples 5 and 6, it was understood that the gas separation membrane produced by performing the ultraviolet ozone treatment step using light free from ultraviolet rays having a wavelength of 185 nm had poor gas separation performance. Specifically, the gas separation membranes of Comparative Examples 1, 3, 5, and 6 were membranes in which the pressure was able to be held so that the evaluation was able to be performed, but these membranes respectively had a relatively low gas separation selectivity and a high gas permeability of 40 GPU or greater, among the membranes evaluated as “C” in which the gas permeability (permeability Q_{CO2} of CO₂) was 10 GPU or greater and the gas separation selectivity was less than 10. In a case where the cumulative irradiation dose was low or the membrane was not irradiated as in these comparative examples, since a functional layer for gas separation was not formed, the performance of the membrane was close to the performance of the material (PDMS, manufactured by Momentive Performance Materials Inc.) itself.

As shown in Comparative Examples 2 and 4, it was understood that the gas separation membrane produced by performing the ultraviolet ozone treatment step under a condition in which the cumulative irradiation dose of ultraviolet rays having a wavelength of 185 nm and the cumulative irradiation dose of ultraviolet rays having a wavelength of 254 nm were respectively greater than the lower limit defined in the present invention had poor gas permeation performance. Specifically, the gas separation membranes of Comparative Examples 2 and 4 were membranes in which the pressure was able to be held so that the evaluation was able to be performed, but these membranes respectively had a low gas permeability, among the membranes evaluated as “C” in which the gas permeability (permeability Q_{CO2} of CO₂) was less than 10 GPU and the gas separation selectivity was less than 30. The reason for this was considered that the amount of the silica component of the functional layer was increased in a case where the cumulative irradiation dose was high so that a vitrified surface was covered by the layer, and thus any gas was unlikely to pass through the layer.

### Examples 101 to 106

—Formation of Module—

Spiral type modules were prepared using the gas separation membranes prepared in Examples 1 to 6 with reference to paragraphs <0012> to <0017> of JP1993-168869A (JP-H05-168869A). The obtained gas separation membrane modules were made into gas separation membrane modules of Examples 101 to 106.

It was confirmed that the prepared gas separation membrane modules of Examples 101 to 106 were excellent based on the performance of the gas separation membranes incorporated therein.

In the prepared gas separation membrane modules of Examples 101 to 106, ten portions having a size of 1 cm×1 cm were randomly collected from the center of one surface of a leaf (leaf indicates a portion of a gas separation membrane in which the space on the permeation side in the spiral type module is connected to the central tube and which is folded into an envelope shape with a size of 10 cm×10 cm) and the element ratios of the surface in the depth direction were calculated according to the method of Example 1, and then the modules were confirmed to have the performance as understood from the gas separation membranes incorporated therein based on nine or more out of ten portions. It was confirmed that the spiral modules were excellent as the performance of the gas separation membranes incorporated therein.

### EXPLANATION OF REFERENCES

1: additional resin layer
2: resin layer precursor
3: resin layer
4: support
4R: support roll
5: ultraviolet ozone treatment
6: surface of resin layer
7: surface of resin layer at depth d from surface of resin layer (in direction of support)
8: protective layer
10: gas separation membrane
10R: gas separation membrane roll
11: polydimethylsiloxane film on which ultraviolet ozone treatment step has not been performed
12: polydimethylsiloxane film into which oxygen atoms are uniformly introduced in film thickness direction
d: depth from surface of resin layer (in direction of support)
20, 50: producing device
22: drying device
24, 52: supply unit
26: coating unit
28: exposing device
30, 58: winding unit
31, 61: rotating shaft
32: coating device
34, 64: backup roller
38a to 38e, 68a to 68e: pass roller
40, 70: winding shaft
56: drying device
80: ultraviolet ozone treatment device
110: composite
110R: composite roll

What is claimed is:

1. A method of producing a gas separation membrane, comprising:
an ultraviolet ozone treatment of irradiating a resin layer precursor which has a siloxane bond with light containing ultraviolet rays having a wavelength of 185 nm and ultraviolet rays having a wavelength of 254 nm to form a resin layer that contains a compound having a siloxane bond,
wherein a cumulative irradiation dose of the ultraviolet rays having a wavelength of 185 nm is in a range of 6.0 to 17.0 J/cm²,
a cumulative irradiation dose of the ultraviolet rays having a wavelength of 254 nm is in a range of 120 to 330 J/cm², and
the compound having a siloxane bond contained in the resin layer includes at least a repeating unit represented by Formula (2) or a repeating unit represented by Formula (3), 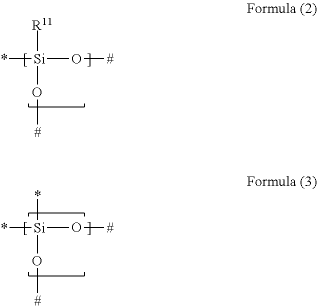
in Formulae (2) and (3), R¹¹ represents a substituent, * represents a bonding site with respect to # in Formula (2) or (3), and # represents a bonding site with respect to * in Formula (2) or (3).

2. The method of producing a gas separation membrane according to claim 1,
wherein the ultraviolet ozone treatment is performed in an oxygen flow.

3. The method of producing a gas separation membrane according to claim 1, further comprising:
unwinding a composite which has the resin layer precursor from a roll; and
winding a gas separation membrane after the ultraviolet ozone treatment around a roll.

4. The method of producing a gas separation membrane according to claim 2, further comprising:
unwinding a composite which has the resin layer precursor from a roll; and
winding a gas separation membrane after the ultraviolet ozone treatment around a roll.

5. The method of producing a gas separation membrane according to claim 1,
wherein the compound having the siloxane bond contained in the resin layer further includes a repeating unit represented by Formula (1), 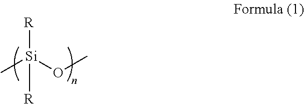
in Formula (1), R's each independently represent a hydrogen atom, an alkyl group having 1 or more carbon atoms, an aryl group, an amino group, an epoxy group, a fluorinated alkyl group, a vinyl group, an alkoxy group, or a carboxyl group, and n represents an integer of 2 or greater.

6. The method of producing a gas separation membrane according to claim 2,
wherein the compound having the siloxane bond contained in the resin layer further includes a repeating unit represented by Formula (1), 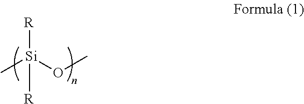
in Formula (1), R's each independently represent a hydrogen atom, an alkyl group having 1 or more carbon atoms, an aryl group, an amino group, an epoxy group, a fluorinated alkyl group, a vinyl group, an alkoxy group, or a carboxyl group, and n represents an integer of 2 or greater.

7. The method of producing a gas separation membrane according to claim 3,
wherein the compound having the siloxane bond contained in the resin layer further includes a repeating unit represented by Formula (1), 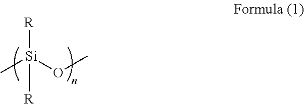
in Formula (1), R's each independently represent a hydrogen atom, an alkyl group having 1 or more carbon atoms, an aryl group, an amino group, an epoxy group, a fluorinated alkyl group, a vinyl group, an alkoxy group, or a carboxyl group, and n represents an integer of 2 or greater.

8. The method of producing a gas separation membrane according to claim 4,
wherein the compound having the siloxane bond contained in the resin layer further includes a repeating unit represented by Formula (1), 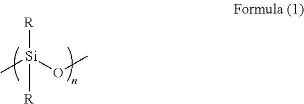
in Formula (1), R's each independently represent a hydrogen atom, an alkyl group having 1 or more carbon atoms, an aryl group, an amino group, an epoxy group, a fluorinated alkyl group, a vinyl group, an alkoxy group, or a carboxyl group, and n represents an integer of 2 or greater.

9. The method of producing a gas separation membrane according to claim 5,
wherein the surface of the resin layer contains a compound having a siloxane bond which has a repeating unit represented by Formula (1) and a repeating unit represented by Formula (2) or a repeating unit represented by Formula (3).

10. The method of producing a gas separation membrane according to claim 1,
wherein a thickness of the resin layer is in a range of 0.4 to 5 μm.

11. The method of producing a gas separation membrane according to claim 1,
wherein the resin layer contains a compound having a repeating unit that contains at least a silicon atom, an oxygen atom, and a carbon atom.

12. The method of producing a gas separation membrane according to claim 1 which further includes a support.

13. A gas separation membrane which is produced according to the method of producing a gas separation membrane according to claim 1.

14. The gas separation membrane according to claim 13 which has a roll shape.

15. A gas separation membrane module comprising:
the gas separation membrane according to claim 13.

16. A gas separator comprising:
the gas separation membrane module according to claim 15.
